(19) United States
(12) Patent Application Publication
(10) Pub. No.: US 2010/0207467 A1
(43) Pub. Date: Aug. 19, 2010

(54) STATOR AND ROTATING ELECTRIC MACHINE

(76) Inventors: Hiroaki Urano, Nishikamo-gun (JP); Masaki Matsuyama, Osaka-shi (JP); Yutaka Komatsu, Nagoya-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 12/738,566

(22) PCT Filed: Oct. 15, 2008
(86) PCT No.: PCT/JP2008/068643

§ 371 Date: Apr. 16, 2010

(30) Foreign Application Priority Data
Oct. 19, 2007 (JP) 2007-272428

(51) Int. Cl. H02K 3/28

(52) U.S. Cl. 310/71

(57) ABSTRACT

A stator includes an annular stator core having a plurality of tooth portions, a plurality of stator coils wound around the plurality of tooth portions, respectively, and a busbar provided radially outward in the stator core relative to the stator coils, for electrically connecting the plurality of stator coils to one another. The busbar is arranged like a windmill on an axial end surface of the stator core.

### TECHNICAL FIELD

The present invention relates to a stator and a rotating electric machine, and more particularly to a stator including a plurality of stator coils and a busbar for connecting the plurality of stator coils to one another and a rotating electric machine including the stator.

### BACKGROUND ART

A stator including a plurality of stator coils and a busbar for connecting the plurality of stator coils to one another has been conventionally known.

For example, Japanese Patent Laying-Open No. 2005-137174 (Patent Document 1) describes a stator structure including stator coils wound around and attached to respective teeth being connected to one another by means of a transition member projecting in an axial direction with respect to the coils, in which an end portion on an outer circumferential side of one coil and an end portion on an inner circumferential side of another coil are connected to each other.

Japanese Patent Laying-Open No. 2005-51999 (Patent Document 2) and Japanese Patent Laying-Open No. 2006-333685 (Patent Document 3) describe connecting a plurality of stator coils to one another by means of busbars provided radially outward relative to the coils.

### Patent Document 1: Japanese Patent Laying-Open No. 2005-137174

### Patent Document 2: Japanese Patent Laying-Open No. 2005-51999

### Patent Document 3: Japanese Patent Laying-Open No. 2006-333685

### DISCLOSURE OF THE INVENTION

### Problems to be Solved by the Invention

In the stator of Patent Document 1, a transition line for connecting the plurality of stator coils projects in the axial direction with respect to the stator coils, which increases the stator in size in the axial direction.

In the stators of Patent Documents 2 and 3, the busbar varies in shape from phase to phase, which increases the number of components.

The present invention was made in view of the above problems, and an object thereof is to provide a stator which is not increased in size and has a smaller number of components, and a rotating electric machine including the stator.

### Means for Solving the Problems

In one aspect, a stator according to the present invention includes an annular stator core having a plurality of tooth portions, a plurality of stator coils wound around the plurality of tooth portions, respectively, and a busbar provided radially outward in the stator core relative to the stator coils, for electrically connecting the plurality of stator coils to one another, in which a distance between one end of the busbar and a center of the annular stator core and a distance between the other end of the busbar and the center of the annular stator core are different from each other.

In another aspect, a stator according to the present invention includes an annular stator core having a plurality of tooth portions, a plurality of first-phase stator coils wound around the plurality of tooth portions, respectively, a plurality of second-phase stator coils wound around the plurality of tooth portions, respectively, and supplied with a current out of phase with a current through the first-phase stator coils, a first busbar provided radially outward in the stator core relative to the first-phase stator coils, for electrically connecting the plurality of first-phase stator coils to one another, and a second busbar provided radially outward in the stator core relative to the second-phase stator coils, for electrically connecting the plurality of second-phase stator coils to one another, in which a distance between an end portion of the first busbar and a center of the annular stator core and a distance between an end portion of the second busbar and the center of the annular stator core are equal to each other.

In yet another aspect, a stator according to the present invention includes an annular stator core having a plurality of tooth portions, a plurality of stator coils wound around the plurality of tooth portions, respectively, and a plurality of busbars provided radially outward in the stator core relative to the stator coils, for electrically connecting the plurality of stator coils to one another, in which the plurality of busbars are arranged like a windmill on an axial end surface of the stator core.

In any of the aspects, the above structure can suppress increase in size of the stator, and reduce the number of components of the stator.

Preferably, in the above stator, a surface of the busbar is covered with insulating coating. As such, insulation of the busbar can be readily ensured, which eliminates the need for another component for insulation.

A rotating electric machine according to the present invention includes the stator described above. A rotating electric machine in which increase in size of a stator is suppressed is thus provided.

Two or more of the aforementioned features may be combined with one another as appropriate.

### EFFECTS OF THE INVENTION

According to the present invention, increase in size of a stator can be suppressed, and the number of components of the stator can be reduced.

### BRIEF DESCRIPTION OF THE DRAWINGS

FIG. 1 shows a rotating electric machine including a stator according to an embodiment of the present invention.

FIG. 2 is a cross-sectional view along II-II in FIG. 1.

FIG. 3 is a perspective view of an insulator and a coil shown in FIG. 2.

FIG. 4 is a cross-sectional view of another portion of a busbar and a busbar accommodating body shown in FIG. 2.

FIG. 5 shows a structure in FIG. 4 viewed from a direction indicated with an arrow V.

FIG. 6 shows in detail arrangement of the busbar shown in FIG. 1.

### DESCRIPTION OF THE REFERENCE SIGNS

1 rotating electric machine; 100 stator; 110 stator core; 111 tooth portion; 120 stator coil; 120U U-phase coil; 120V V-phase coil; 120W W-phase coil; 121, 131 terminal portion; 130 busbar; 130U U-phase busbar; 130V V-phase busbar; 130W W-phase busbar; 140 busbar accommodating body; 150 insulator; 200 rotor.

### BEST MODES FOR CARRYING OUT THE INVENTION

Embodiments of the present invention will be described below. It is noted that the same or corresponding parts have the same reference characters, and description thereof may not be repeated.

If any reference to a number, an amount and the like is made in embodiments described below, the scope of the present invention is not necessarily limited to that number, amount and the like unless otherwise specified. Further, in the following embodiments, each constituent element is not necessarily essential to the present invention unless otherwise specified. Furthermore, if there are a plurality of embodiments below, it is originally intended to combine features of the embodiments to one another as appropriate unless otherwise specified.

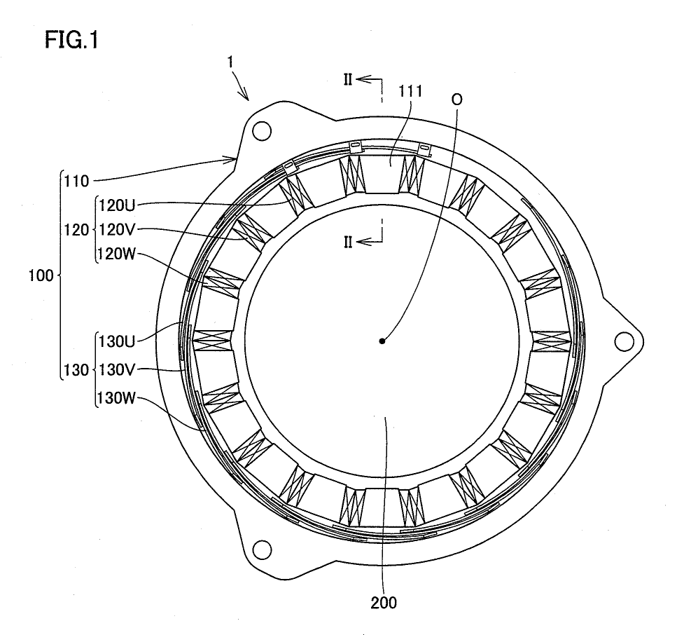

FIG. 1 shows a rotating electric machine including a stator according to an embodiment of the present invention. Referring to FIG. 1, rotating electric machine 1 includes a stator 100 and a rotor 200. Stator 100 includes a stator core 110, a stator coil 120, and a busbar 130.

Stator core 110 is structured by stacking magnetic bodies such as electromagnetic steel plates. Stator core 110 includes a plurality of tooth portions 111 and slot portions formed among the plurality of tooth portions 111.

Stator coil 120 is wound around tooth portion 111 such that stator coil 120 fits in the slot portion of stator core 110. Stator coil 120 includes a U-phase coil 120U, a V-phase coil 120V, and a W-phase coil 130W. U-phase coil 120U, V-phase coil 120V, and W-phase coil 120W are arranged to be aligned repeatedly in this order at regular intervals in a circumferential direction of stator 100. In the example of FIG. 1, six U-phase coils 120U, six V-phase coils 120V, and six W-phase coils 120W are provided. U-phase coil 120U, V-phase coil 120V, and W-phase coil 120W are supplied with AC currents out of phase with one another by 120°, respectively. That is, rotating electric machine 1 is a three-phase motor generator having a U-phase, a V-phase, and a W-phase.

As shown in FIG. 1, one stator coil 120 is wound around each of tooth portions 111. That is, a winding structure of “concentrated winding” where one stator coil 120 is wound around and attached to one tooth portion 111 is applied to stator 100 according to the present embodiment.

Busbar 130 includes a U-phase busbar 130U, a V-phase busbar 130V, and a W-phase busbar 130W. U-phase coils 120U are electrically connected in series by U-phase busbar 130U, V-phase coils 120V are electrically connected in series by V-phase busbar 130V, and W-phase coils 120W are electrically connected in series by W-phase busbar 130W.

As shown in FIG. 1, U-phase busbar 130U, V-phase busbar 130V, and W-phase busbar 130W are arranged like a windmill on an axial end surface of stator core 110. More specifically, each busbar 130 is provided to extend in an oblique direction that crosses a radial direction and a tangential direction of stator 100. Namely, each busbar 130 is arranged such that distances from a center O of annular stator core 110 to one end and the other end of the busbar are different from each other. In order to readily ensure that busbar 130 is insulated, a surface of busbar 130 is covered with insulating coating.

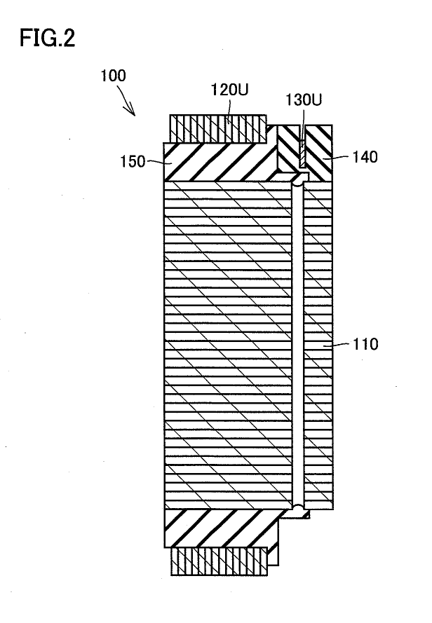

FIG. 2 is a cross-sectional view along II-II in FIG. 1. Referring to FIG. 2, busbar 130 (U-phase busbar 130U in the case of FIG. 2) fits in a busbar accommodating body 140 made of insulative resin. An insulator 150 which is a component formed from resin is interposed between stator core 110 and stator coil 120 (U-phase coil 120U in the case of FIG. 2).

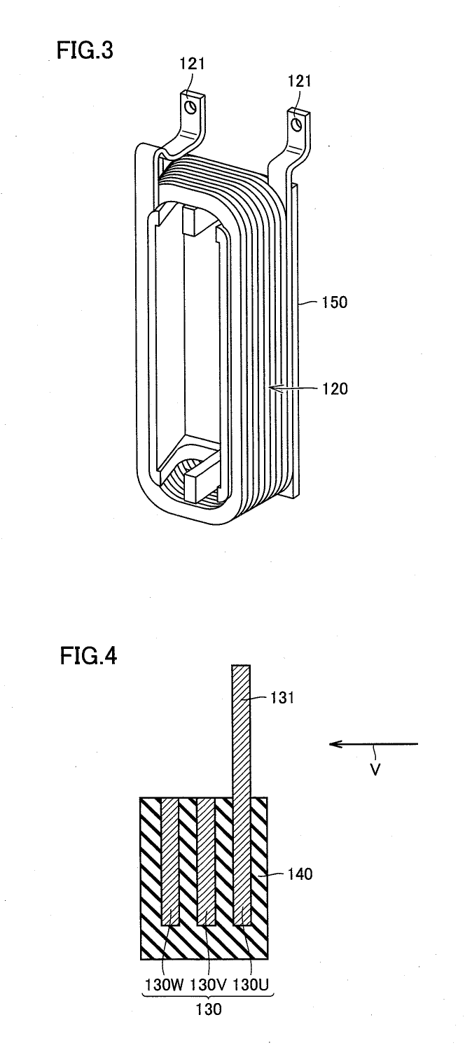

When winding and attaching stator coil 120 around stator core 110, first, stator coil 120 is wound around insulator 150, to form a cassette coil having a terminal portion 121 as shown in FIG. 3. By fitting the cassette coil shown in FIG. 3 in tooth portion 111 of stator core 110, stator coil 120 and stator core 110 are assembled.

FIG. 4 is a cross-sectional view of busbar 130 and busbar accommodating body 140 (a cross-sectional view of a portion different from that shown in FIG. 2), and FIG. 5 shows the structure in FIG. 4 viewed from a direction indicated with an arrow V. In the cross-section shown in FIG. 4, busbar accommodating body 140 accommodates three busbars 130 (U-phase busbar 130U, V-phase busbar 130V, and W-phase busbar 130W). As shown in FIGS. 4 and 5, U-phase busbar 130U projects upward from busbar accommodating body 140 to form a terminal portion 131.

Terminal portions 131 provided at both end portions of busbar 130 and terminal portions 121 of stator coil 120 are fastened to one another by a fastening member such as a bolt. In this manner, the plurality of stator coils 120 are electrically connected to one another.

By arranging busbar 130 radially outward relative to stator coil 120 as described above, busbar 130 does not need to project in the axial direction with respect to stator coil 120 in electrically connecting the plurality of stator coils 120 to one another by busbar 130, thereby suppressing increase in size of stator 100 in the axial direction.

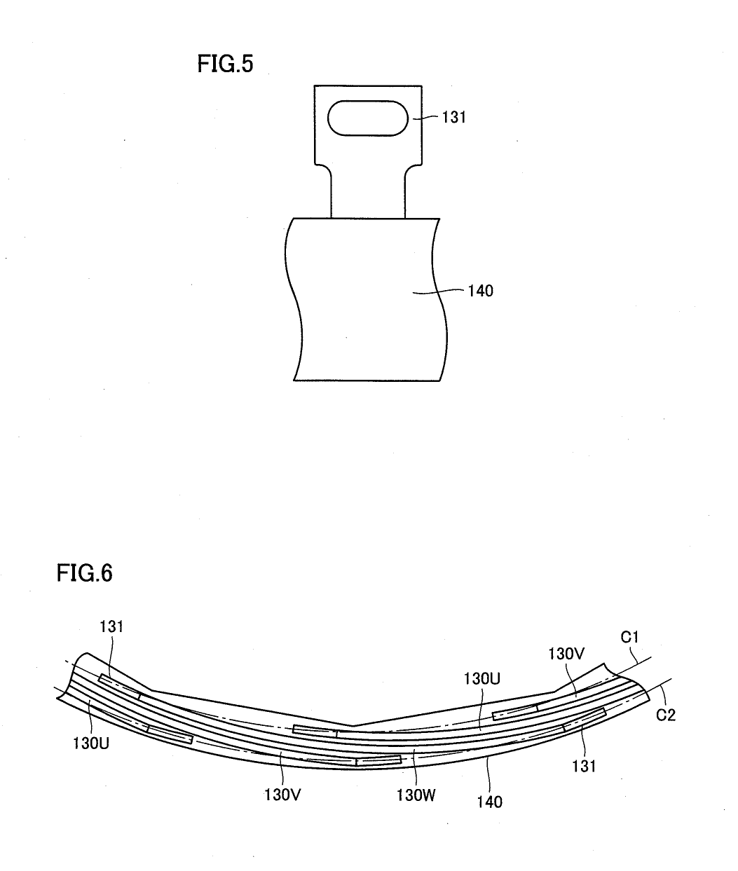

FIG. 6 shows in detail the arrangement of busbar 130 shown in FIG. 1. Referring to FIG. 6, one end portions of U-phase busbar 130U, V-phase busbar 130V, and W-phase busbar 130W, respectively, are positioned on the same circumference (on a line C1 in FIG. 6) around center O of annular stator core 110, and the other end portions of U-phase busbar 130U, V-phase busbar 130V, and W-phase busbar 130W, respectively, are positioned on the same circumference (on a line C2 in FIG. 6) around center O of annular stator core 110. This arrangement allows U-phase busbar 130U, V-phase busbar 130V, and W-phase busbar 130W to be identical in shape, thereby reducing the number of components of stator 100.

According to stator 100 in the present embodiment, increase in size of stator 100 can be suppressed, and the number of components of stator 100 can be reduced.

The above description is summarized as follows. That is, stator 100 according to the present embodiment includes annular stator core 110 having the plurality of tooth portions 111; U-phase coil 120U (first-phase stator coil), V-phase coil 120V (second-phase stator coil), and W-phase coil 120W (third-phase stator coil) as a plurality of “stator coils” wound around the plurality of tooth portions 111, respectively; and U-phase busbar 130U (first busbar), V-phase busbar 130V (second busbar), and W-phase busbar 130W (third busbar) provided radially outward in stator core 110 relative to U-phase coil 120U, V-phase coil 120V, and W-phase coil 120W, for electrically connecting the plurality of U-phase coils 120U, V-phase coils 120V, and W-phase coils 120W to one another. U-phase coil 120U, V-phase coil 120V, and W-phase coil 120W are supplied with AC currents out of phase with one another, respectively.

Here, a distance between one end of U-phase busbar 130U and center O of annular stator core 110 and a distance between the other end of U-phase busbar 130U and center O of annular stator core 110 are different from each other, a distance between one end of V-phase busbar 130V and center O of annular stator core 110 and a distance between the other end of V-phase busbar 130V and center O of annular stator core 110 are different from each other, and a distance between one end of W-phase busbar 130W and center O of annular stator core 110 and a distance between the other end of W-phase busbar 130W and center O of annular stator core 110 are different from each other.

Further, a distance between an end portion of U-phase busbar 130U and center O of annular stator core 110 and a distance between an end portion of V-phase busbar 130V and center O of annular stator core 110 are equal to each other, the distance between the end portion of V-phase busbar 130V and center O of annular stator core 110 and a distance between an end portion of W-phase busbar 130W and center O of annular stator core 110 are equal to each other, and the distance between the end portion of W-phase busbar 130W and center O of annular stator core 110 and the distance between the end portion of U-phase busbar 130U and center O of annular stator core 110 are equal to each other.

While the embodiments of the present invention have been described as above, it should be understood that the embodiments disclosed herein are illustrative and non-restrictive in every respect. The scope of the present invention is defined by the terms of the claims, and is intended to include any modifications within the scope and meaning equivalent to the terms of the claims.

### INDUSTRIAL APPLICABILITY

The present invention is applicable, for example, to a stator including a plurality of stator coils and a busbar for connecting the plurality of stator coils to one another and a rotating electric machine including the stator.

1. A stator comprising:
an annular stator core including a plurality of tooth portions;
a plurality of stator coils wound around said plurality of tooth portions, respectively; and
a busbar provided radially outward in said stator core relative to said stator coils, for electrically connecting said plurality of stator coils to one another,
said busbar being electrically connected to said stator coils at both end portions thereof,
said stator coil including a portion wound around said tooth portion, a terminal portion provided radially outward in said stator core relative to said tooth portion and connected to said busbar, and a portion formed to stride over the portion wound around said tooth portion and connecting the portion wound around said tooth portion and said terminal portion to each other, and
a distance between one end of said busbar and a center of said annular stator core and a distance between the other end of said busbar and the center of said annular stator core being different from each other.

2. The stator according to claim 1, wherein
a surface of said busbar is covered with insulating coating.

3. A rotating electric machine, comprising the stator according to claim 1.

4. A stator comprising:
an annular stator core including a plurality of tooth portions;
a plurality of first-phase stator coils wound around said plurality of tooth portions, respectively;
a plurality of second-phase stator coils wound around said plurality of tooth portions, respectively, and supplied with a current out of phase with a current through said first-phase stator coils;
a first busbar provided radially outward in said stator core relative to said first-phase stator coils, for electrically connecting said plurality of first-phase stator coils to one another; and
a second busbar provided radially outward in said stator core relative to said second-phase stator coils, for electrically connecting said plurality of second-phase stator coils to one another,
said first busbar being electrically connected to said first-phase stator coils at both end portions thereof,
said second busbar being electrically connected to said second-phase stator coils at both end portions thereof,
said first-phase stator coil including a first portion wound around said tooth portion, a first terminal portion provided radially outward in said stator core relative to said tooth portion and connected to said first busbar, and a second portion formed to stride over the first portion wound around said tooth portion and connecting the first portion wound around said tooth portion and said first terminal portion to each other,
said second-phase stator coil including a third portion wound around said tooth portion, a second terminal portion provided radially outward in said stator core relative to said tooth portion and connected to said second busbar, and a fourth portion formed to stride over the third portion wound around said tooth portion and connecting the third portion wound around said tooth portion and said second terminal portion to each other, and
a distance between the end portion of said first busbar and a center of said annular stator core and a distance between the end portion of said second busbar and the center of said annular stator core being equal to each other.

5. The stator according to claim 4, wherein
a surface of said first busbar and a surface of said second busbar are covered with insulating coating.

6. A rotating electric machine, comprising the stator according to claim 4.

7. A stator comprising:
an annular stator core including a plurality of tooth portions;
a plurality of stator coils wound around said plurality of tooth portions, respectively; and
a plurality of busbars provided radially outward in said stator core relative to said stator coils for electrically connecting said plurality of stator coils to one another,
said stator coil including a portion wound around said tooth portion, a terminal portion provided radially outward in said stator core relative to said tooth portion and connected to said busbar, and a portion formed to stride over the portion wound around said tooth portion and connecting the portion wound around said tooth portion and said terminal portion to each other, and
said plurality of busbars being arranged like a windmill on an axial end surface of said stator core.

8. The stator according to claim 7, wherein surfaces of said busbars are covered with insulating coating.

9. A rotating electric machine, comprising the stator according to claim 7.

10. A stator comprising:
an annular stator core including a plurality of tooth portions;
a plurality of first-phase stator coils wound around said plurality of tooth portions, respectively;
a plurality of second-phase stator coils wound around said plurality of tooth portions, respectively, and supplied with a current out of phase with a current through said first-phase stator coils;
a first busbar provided radially outward in said stator core relative to said first-phase stator coils, for electrically connecting said plurality of first-phase stator coils to one another; and
a second busbar provided radially outward in said stator core relative to said second-phase stator coils, for electrically connecting said plurality of second-phase stator coils to one another,
said first busbar being electrically connected to said first-phase stator coils at both end portions thereof,
said second busbar being electrically connected to said second-phase stator coils at both end portions thereof,
said first busbar and said second busbar being provided on an identical axial end surface of said stator core, and
a distance between the end portion of said first busbar and a center of said annular stator core and a distance between the end portion of said second busbar and the center of said annular stator core being equal to each other.

11. The stator according to claim 10, wherein
a surface of said first busbar and a surface of said second busbar are covered with insulating coating.

12. A rotating electric machine, comprising the stator according to claim 10.

13. The stator according to claim 1, further comprising a busbar accommodating body provided radially outward relative to said tooth portion, for accommodating a plurality of said busbars, wherein
said plurality of busbars are electrically connected to said plurality of stator coils at portions thereof projecting upward from said busbar accommodating body.

14. The stator according to claim 1, further comprising an insulator interposed between said stator core and said stator coil.

15. The stator according to claim 4, further comprising a busbar accommodating body provided radially outward relative to said tooth portion, for accommodating said first busbar and said second busbar, wherein
said first busbar is electrically connected to said first-phase stator coil at a portion thereof projecting upward from said busbar accommodating body, and
said second busbar is electrically connected to said second-phase stator coil at a portion thereof projecting upward from said busbar accommodating body.

16. The stator according to claim 4, further comprising insulators interposed between said stator core and said first-phase stator coil and between said stator core and said second-phase stator coil, respectively.

17. The stator according to claim 7, further comprising a busbar accommodating body provided radially outward relative to said tooth portion, for accommodating said plurality of busbars, wherein
said plurality of busbars are electrically connected to said plurality of stator coils at portions thereof projecting upward from said busbar accommodating body.

18. The stator according to claim 7, further comprising an insulator interposed between said stator core and said stator coil.

19. The stator according to claim 10, further comprising a busbar accommodating body provided radially outward relative to said tooth portion, for accommodating said first busbar and said second busbar, wherein
said first busbar is electrically connected to said first-phase stator coil at a portion thereof projecting upward from said busbar accommodating body, and
said second busbar is electrically connected to said second-phase stator coil at a portion thereof projecting upward from said busbar accommodating body.

20. The stator according to claim 10, further comprising insulators interposed between said stator core and said first-phase stator coil and between said stator core and said second-phase stator coil, respectively.
